(19) United States
(12) Patent Application Publication
(10) Pub. No.: US 2014/0043811 A1
(43) Pub. Date: Feb. 13, 2014

(54) LED LIGHTING UNIT

(71) Applicant: Yazaki Corporation, Tokyo (JP)

(72) Inventor: Harumi KAWASE, Makinohara-shi (JP)

(73) Assignee: Yazaki Corporation, Tokyo (JP)

(21) Appl. No.: 14/055,181

(22) Filed: Oct. 16, 2013

Related U.S. Application Data
(63) Continuation of application No. PCT/JP2012/061308, filed on Apr. 20, 2012.

(30) Foreign Application Priority Data
Apr. 22, 2011 (JP) 2011-095812

(51) Int. Cl. F21K 99/00

(52) U.S. Cl. CPC F21K 9/50
USPC 362/235

(57) ABSTRACT

An LED lighting unit having a circuit board on which a plurality of LED elements are mounted and a light transmitting housing in which the circuit board is accommodated. The LED lighting unit includes a light screen cover formed so as to cover an outer surface of the light transmitting housing and having light output opening parts formed on walls of the light screen cover respectively opposed to the plurality of LED elements and a light screen member which screens in an inner part of walls of the transmitting housing lights guided in the walls of the transmitting housing so that the lights emitted respectively from the plurality of LED elements are guided in the walls of the transmitting housing and do not interfere with each other.

### CROSS REFERENCE TO RELATED APPLICATION

This application is a continuation of PCT application No. PCT/JP2012/061308, which was filed on Apr. 20, 2012 based on Japanese Patent Application No. 2011-095812 filed on Apr. 22, 2011, the contents of which are incorporated herein by reference.

### BACKGROUND OF THE INVENTION

1. Technical Field

The present invention relates to an LED lighting unit having a circuit board on which a plurality of LED elements, are mounted and a light transmitting housing in which the circuit board is accommodated.

2. Background Art

Usually, a device is known that a plurality of LED elements are provided on a circuit board and lights emitted respectively from the LED elements are used as illuminating lights or colored lights such as orange are emitted from the LED elements to show an operating state of the device. For instance, PTL 1 proposes a display device for a vehicle which functions as what is called an indicator by lights emitted from a plurality of LED elements.

### CITATION LIST

### Patent Literature

[PTL 1] JP-A-11-101664

### SUMMARY OF THE INVENTION

The display device for the vehicle disclosed in the PTL 1 includes scales arranged in the forms of circles or circular arcs in a dial, indexes such as figures, characters or symbols attached to the scales, one or a plurality of light sources arranged so as to individually correspond to the scales of the dial respectively and a display control unit which sets a measured value as a reference value to turn on the light sources within a prescribed range of the reference value or lower and brighten the scales within the prescribed range corresponding to a measured amount so that the prescribed range is displayed on the dial. Thus, the measured amount is displayed in cooperation of the display of the prescribed range with the indexes such as the figures, the characters or the symbols attached to the scales of the dial.

However, in the display device for the vehicle disclosed in the PTL 1, since the LED elements are respectively arranged in individually partitioned spaces by light screen plates and light screen base parts so that the lights respectively emitted from the LED elements do not mutually interfere, the individual spaces are liable to be filled with heat emitted from the LED elements respectively. As a result, there is possibility in that a heat load applied to a circuit board is increased.

The present invention is made in views of these situations and possibilities. It is an object of the present invention to provide an LED lighting unit which can reduce an interference of lights and a head load applied to a circuit board can be reduced even when a plurality of LED elements are provided on the circuit board.

In order to achieve the object, an LED lighting unit defined in a first aspect of the present invention has a circuit board on which a plurality of LED elements are mounted and a light transmitting housing in which the circuit board is accommodated, the LED lighting unit including a light screen cover formed so as to cover an outer surface of the light transmitting housing and having light output opening parts formed on walls of the light screen cover respectively opposed to the plurality of LED elements, and a light screen member which screens in an inner part of walls of the transmitting housing lights guided in the walls of the transmitting housing so that the lights emitted respectively from the plurality of LED elements are guided in the walls of the transmitting housing and do not interfere with each other.

Further, in an LED lighting unit defined in a second aspect of the present invention in the above-described invention, the light transmitting housing has an insert opening part as an opening formed on the wall of the transmitting housing so that at least a part of the light screen member is inserted, or a fitting recessed part recessed in the wall of the light transmitting housing so that at least a part of the light screen member is fitted thereto, and the light screen member is inserted into the insert opening part or fitted to the fitting recessed part so that the light screen member is held and fixed to the light transmitting housing.

Further, in an LED lighting unit defined in a third aspect of the invention in the above-described invention, the light screen member has a cross-sectional form of T and includes an insert protruding part as a protruding part corresponding to a vertical line of the form of T and inserted into the insert opening part or a fitting protruding part fitted to the fitting recessed part and an abutting part as a part corresponding to a transverse line of the form of T and having a first abutting surface as a surface of the insert protruding part side or the fitting protruding part side and allowed to abut on an outer surface of the light transmitting housing and a second abutting surface as a back side surface of the first abutting surface and allowed to abut on an inner surface of the light screen cover.

Further, in an LED lighting unit defined in a fourth aspect of the present invention, in the above-described invention, the light screen member is arranged on the wall of the light transmitting housing located near and opposed to each of the plurality of LED elements so as to surround each of the LED elements.

The LED lighting unit 1 according to the first aspect of the present invention includes the circuit board on which the plurality of LED elements, are mounted and the light transmitting housing in which the circuit board is accommodated. Further, the LED lighting unit includes the light screen cover which is formed so as to cover the outer surface of the light transmitting housing and has the light output opening parts formed on the walls respectively opposed to the plurality of LED elements and the light screen member which screens in the inner part of the wall the lights guided in the inner part of the wall of the light transmitting housing so that the lights respectively emitted from the plurality of LED elements are guided in the inner part of the wall of the light transmitting housing and do no interfere with each other. Accordingly, since the light screen member screens the lights in the wall of the light transmitting housing without enclosing the LED elements respectively in the individual spaces, even when the plurality of LED elements are provided on the circuit board, an interference of the lights can be reduced and a heat load applied to the circuit board can be reduced.

Further, in the LED lighting unit according to the second aspect of the present invention, the light transmitting housing has the insert opening part as the opening formed on the wall of the light transmitting housing so that at least a part of the light screen member is inserted, or the fitting recessed part recessed in the wall of the light transmitting housing so that at least a part of the light screen member is fitted thereto, and the light screen member is inserted into the insert opening part or fitted to the fitting recessed part so that the light screen member is held and fixed to the light transmitting housing. Thus, since the light screen member passes through the section of the wall of the light transmitting housing or is arranged in the wall of the light transmitting housing, the lights guided in the wall of the light transmitting housing can be effectively screened. As a result, the lights emitted respectively from the LED elements can be effectively prevented from interfering with each other.

Further, in the LED lighting unit according to the third aspect of the present invention, the light screen member has the cross-sectional form of T and includes the insert protruding part as the protruding part corresponding to the vertical line of the form of T and inserted into the insert opening part or the fitting protruding part fitted to the fitting recessed part and the abutting part as the part corresponding to the transverse line of the form of T and having the first abutting surface as the surface of the insert protruding part side or the fitting protruding part side and allowed to abut on the outer surface of the light transmitting housing and the second abutting surface as the back side surface of the first abutting surface and allowed to abut on the inner surface of the light screen cover. Thus, a backlash in an attached state of the light screen cover and the light transmitting housing can be prevented. Further, the heat of the light transmitting housing can be made to go to the light screen cover.

Further, in the LED lighting unit according to the fourth aspect of the present invention, the light screen member is arranged on the wall of the light transmitting housing located near and opposed to each of the plurality of LED elements so as to surround each of the LED elements. Thus, the lights guided in the wall of the light transmitting housing can be effectively screened. As a result, the lights emitted respectively from the LED elements can be effectively prevented from interfering with each other.

### BRIEF DESCRIPTION OF DRAWINGS

FIG. 1 is a perspective view of an LED lighting unit according to an exemplary embodiment of the present invention.

FIG. 2 is a sectional view taken along a line A-A of the LED lighting unit shown in FIG. 1.

FIG. 3 is a plan view of the LED lighting unit shown in FIG. 1.

FIG. 4 is a perspective view of a light transmitting housing to which a light screen member shown in FIG. 1 is attached.

FIG. 5 is a sectional view of the light screen member shown in FIG. 1 which is formed to be tapered.

FIG. 6 is a sectional view of main parts of an LED lighting unit of a first modified example of the exemplary embodiment of the present invention.

FIG. 7 is a sectional view of main parts of an LED lighting unit of a second modified example of the exemplary embodiment of the present invention.

FIG. 8 is a sectional view of main parts of an LED lighting unit of a third modified example of the exemplary embodiment of the present invention.

### DESCRIPTION OF EMBODIMENTS

Now, by referring to the drawings, a preferred exemplary embodiment of an LED lighting unit according to the present invention will be described below in detail.

### Exemplary Embodiment

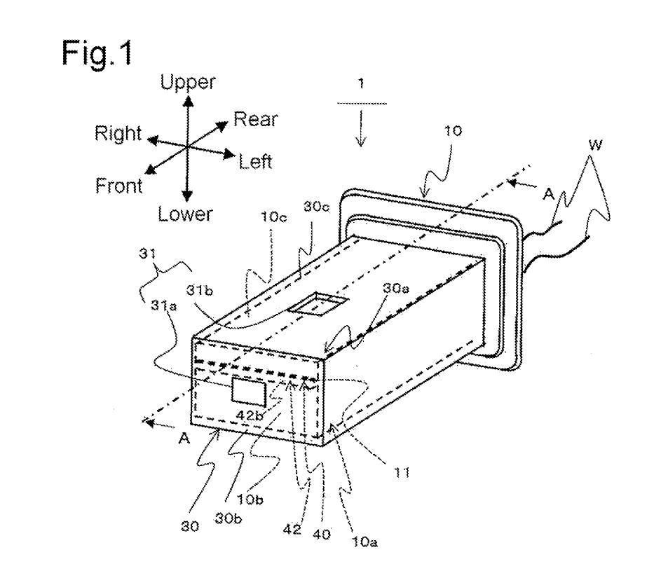

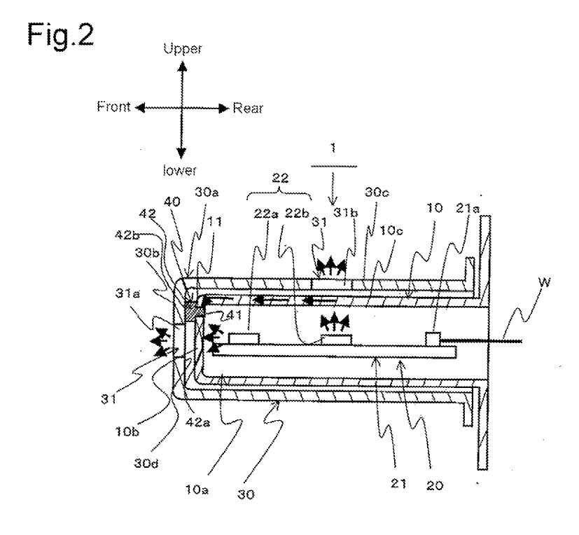

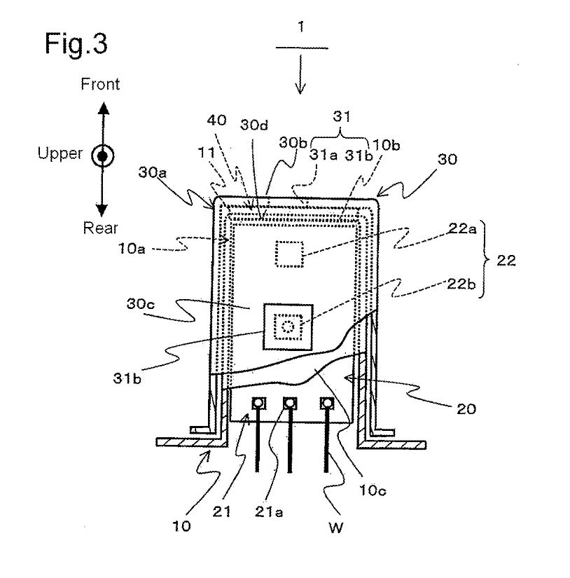

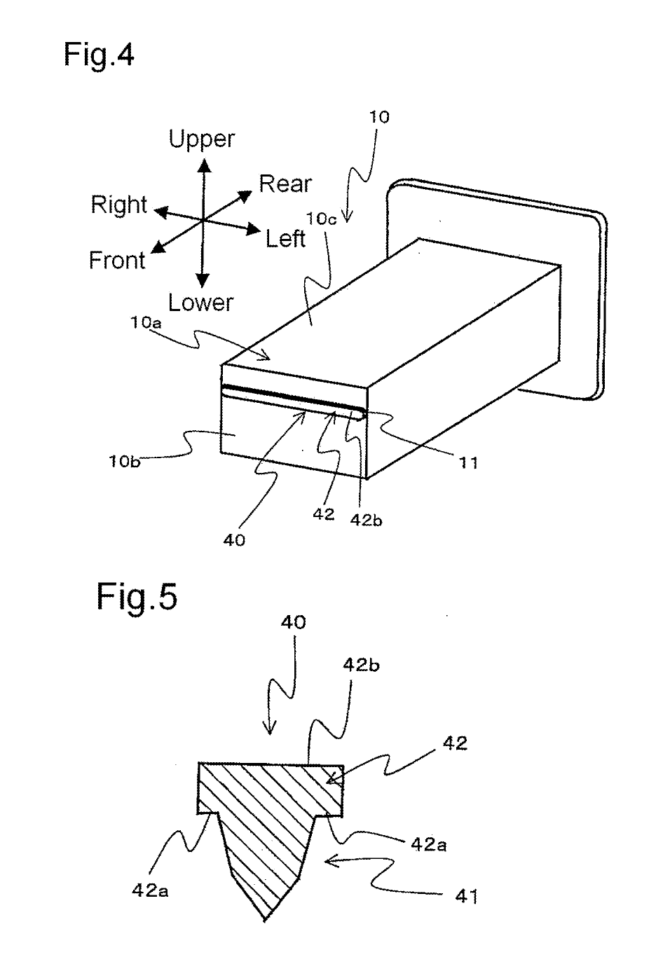

FIG. 1 is a perspective view of the LED lighting unit 1 according to the exemplary embodiment of the present invention. FIG. 2 is a sectional view taken along a line A-A of the LED lighting unit shown in FIG. 1. FIG. 3 is a plan view of the LED lighting unit shown in FIG. 1. FIG. 4 is a perspective view of a light transmitting housing 10 to which a light screen member 40 shown in FIG. 1 is attached. FIG. 5 is a sectional view of the light screen member 40 shown in FIG. 1 which is formed to be tapered.

For convenience sake, mutually orthogonal directions shown by arrow marks in the drawing are set to front and rear, right and left and upper and lower directions.

The LED lighting unit 1 according to the exemplary embodiment of the present invention includes a light transmitting housing 10, an LED unit part 20, a light screen cover 30 and a light screen member 40.

Initially, the light transmitting housing 10 will be described.

The light transmitting housing 10 is made of a light transmitting synthetic resin and has a square tubular form with a bottom and a front end part 10a closed. A below-described circuit board 21 is accommodated in the light transmitting housing 10. The light transmitting housing 10 has an insert opening part 11. The insert opening part 11 is an opening formed on a wall of the light transmitting housing 10 so that at least a part of the light screen member 40 is inserted.

Now, the LED unit part 20 will be described below.

The LED unit part 20 includes the circuit board 21, two LED elements 22 and an electric wire W.

The circuit board 21 is realized by what is called a printed wiring board and a conductor pattern such as a power circuit is formed thereon. The circuit board 21 has a plurality of LED elements mounted on the surface of the board. In the present exemplary embodiment, the circuit board is connected to three electric wires W as signal lines or feeder lines through a terminal formed on the board. The electric wires W are respectively connected to the terminal 21a by carrying out a soldering process.

The two LED elements 22 have light emitting parts provided on the surfaces of box shaped packages and power supply input terminals not shown in the drawing are connected to the power circuit on the circuit board 21 not shown in the drawing. The power circuit which is not shown in the drawing is connected to the three electric wires W through the terminal 21a provided on the circuit board 21. The LED elements 22 to which an electric power is supplied through the power circuit are respectively turned on.

The LED element 22 (refer it to as a front side LED element 22a, hereinafter) arranged in a front side position of the circuit board 21 emits, for instance, orange light, and functions as an illumination for showing an operating state of a device depending on the kinds of color. Namely, the LED lighting unit 1 is allowed to function as what is called an indicator.

Further, the LED element 22 (refer it to as a rear side LED element 22b, hereinafter) arranged in a more rearward position on the circuit board 21 than the front side LED element 22a emits white light. Namely, the LED lighting unit 1 is allowed to function as a lighting device.

Now, the light screen cover 30 will be described below.

The light screen cover 30 is made of a black synthetic resin and has a square tubular form with a bottom and a front end part 30a closed. The light screen cover 30 is formed so as to cover an outer surface of the light transmitting housing 10. The light screen cover 30 has two light output opening parts 31 as openings formed so as to output the lights emitted from the two LED elements 22 outside the light screen cover 30.

The two light output opening parts 31 are respectively arranged correspondingly to the arrangements of the LED elements 22 provided on the circuit board 21.

More specifically, the light output opening part 31 (refer it to as a front side light output opening part 31a, hereinafter) arranged correspondingly to the arrangement of the front side LED element 22a of the two light output opening parts 31 is arranged at a position of a front wall 30b of the light screen cover 30 opposed to the front side LED element 22a.

Further, the light output opening part 31 (refer it to as a rear side light output opening part 31b, hereinafter) arranged correspondingly to the arrangement of the rear side LED element 22b is arranged at a position of an upper wall 30c of the light screen cover 30 opposed to the rear side LED element 22b.

Since the outer surface of the light transmitting housing 10 is covered with such a light screen cover 30, after the lights emitted respectively from the LED elements 22 pass through the light transmitting housing 10, the lights are respectively outputted outside the light screen cover 30 through the light output opening parts 31 arranged correspondingly to the LED elements 22.

Now, the light screen member 40 will be described below. The light screen member 40 serves to screen the lights guided by an inner part of the wall of the light transmitting housing 10 so that the lights emitted from the front side LED element 22a and the rear side LED element 22b are guided by the light transmitting housing 10 and do not interfere with each other.

The light screen member 40 is made of a material having a light screening property such as a black rubber material, passes through the wall of the light transmitting housing 10 and is attached to the light transmitting housing 10. More specifically, the light screen member 40 has a cross-sectional form of T and a linear form extending in the transverse direction. The light screen member 40 is attached to a surface in a direction of width of a front wall 10b of the light transmitting housing 10.

Further, specifically, the light screen member 40 has an insert protruding part 41 and an abutting part 42.

The insert protruding part 41 is a protruding part corresponding to a vertical line of the T shaped cross section which passes through and is fitted to the insert opening part 11 of the light transmitting housing.

The abutting part 42 is a part corresponding to a transverse line of the form of T and has a first abutting surface 42a and a second abutting surface 42b.

The first abutting surface 42a is a surface of the insert protruding part side and is allowed to abut on the outer surface of the light transmitting housing 10.

The second abutting surface 42b is a back side surface of the first abutting surface 42a and is allowed to abut on an inner surface of the light screen cover 30.

When the above-described light screen member 40 is attached to the light transmitting housing 10, the insert protruding part 41 is inserted into the insert opening part 11 until the surface 42a of the abutting part 42 is allowed to abut on the outer surface of the light transmitting housing 10, so that the insert part 41 is inserted into the insert opening part 11 with a prescribed depth. Thus, the light screen member 40 is held and fixed to the light transmitting housing 10. Further, since the first abutting surface 42a is allowed to abut on the outer surface of the light transmitting housing 10 and the second abutting surface 42b is allowed to abut on the inner surface of the light screen cover 30, a backlash in an attached state of the light screen cover 30 and the light transmitting housing 10 can be prevented by the light screen member 40. Further, heat of the light transmitting housing 10 can be made to go to the light screen cover 30.

As described above, when the light screen member 40 is attached to the surface in the direction of width of the front wall 10b of the light transmitting housing 10, the lights emitted from the front side LED element 22a and the rear side LED element 22b can be guided by the inner part of the wall of the light transmitting housing 10 and can be prevented from interfering with each other as shown in FIG. 2.

Further, since the LED elements 22 are not respectively partitioned by individual spaces in the light transmitting housing 10 and are arranged on the circuit board 21, the heat generated respectively from the LED elements 22 can be easily radiated. Further, since the light screen member 40 abuts on the light transmitting housing 10 and the light screen cover 30, the heat of the light transmitting housing 10 is easily made to go to the light screen cover 30.

In order to improve a water-proofing performance of the light screen member 40, a longitudinal width and a transverse width of the cross-section of the insert protruding part 41 are preferably set to be respectively larger than those of the insert opening part 11 so that the light screen member 40 may be inserted into the insert opening part 11 by using an elasticity of rubber. Otherwise, in order to improve the water-proofing performance of the light screen member 40, the insert protruding part 41 may be formed in the shape of bellows. Further, as shown in FIG. 5, in the light screen member 40, the insert protruding part 41 is preferably formed to be tapered. In such a way, when the insert protruding part 41 is formed to be tapered, the light screen member 40 can be easily inserted into the insert opening part 11.

The LED lighting unit 1 according to the exemplary embodiment of the present invention includes the circuit board 21 on which the plurality of LED elements 22 are mounted and the light transmitting housing 10 in which the circuit board 21 is accommodated. Further, the LED lighting unit 1 includes the light screen cover 30 which is formed so as to cover the outer surface of the light transmitting housing 10 and has the light output opening parts 31a and 31b formed on the walls 30b and 30c respectively opposed to the plurality of LED elements 22 and the light screen member 40 which screens in the inner part of the wall 10b the lights guided in the inner part of the wall 10b of the light transmitting housing 10 so that the lights respectively emitted from the plurality of LED elements 22 are guided in the inner part of the wall 10b of the light transmitting housing 10 and do no interfere with each other. Accordingly, since the light screen member 40 screens the lights in the wall of the light transmitting housing 10 without enclosing the LED elements 22 respectively in the individual spaces, even when the plurality of LED elements 22 are provided on the circuit board 21, an interference of the lights can be reduced and a heat load applied to the circuit board can be reduced.

Further, the LED lighting unit 1 according to the exemplary embodiment of the present invention has the insert opening part 11 as the opening formed on the wall 10b of the light transmitting housing 10 so that at least a part of the light screen member 40 is inserted. When the light screen member 40 is inserted into the insert opening part 11, the light screen member 40 is held and fixed to the light transmitting housing 10. Thus, since the light screen member 40 passes through the section of the wall of the light transmitting housing 10 and is arranged, the lights guided in the wall of the light transmitting housing 10 can be effectively screened. As a result, the lights emitted respectively from the LED elements 22 can be effectively prevented from interfering with each other.

Further, in the LED lighting unit according to the exemplary embodiment of the present invention, the light screen member 40 has the cross-sectional form of T, and includes the insert protruding part 41 as a protruding part corresponding to the vertical line of the form of T and inserted into the insert opening part 11 and the abutting part 42 as a part corresponding to the transverse line of the form of T which has the first abutting surface 42a and the second abutting surface 42b. The first abutting surface 42a is a side surface of the insert protruding part 41 and is allowed to abut on the outer surface of the light transmitting housing 10. The second abutting surface 42b is a back side surface of the first abutting surface 42a and is allowed to abut on the inner surface of the light screen cover 30. Thus, the backlash in an attached state of the light screen cover 30 and the light transmitting housing 10 can be prevented. Further, the heat of the light transmitting housing can be made to go to the light screen cover.

### First Modified Example

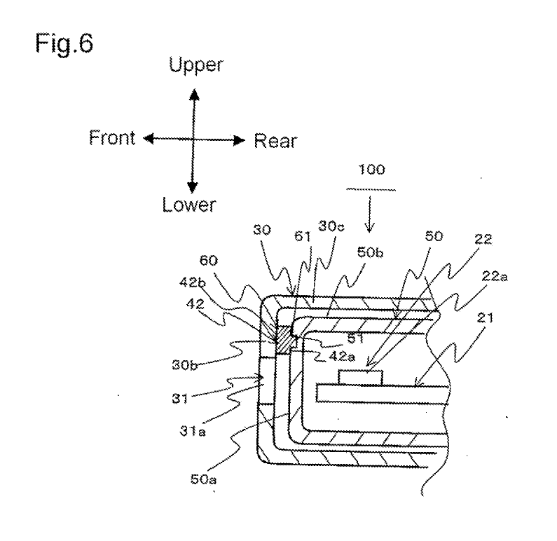

Now, a first modified example of the exemplary embodiment of the present invention will be described below by referring to FIG. 6. FIG. 6 is a sectional view of main parts of an LED lighting unit 100 of a first modified example of the exemplary embodiment of the present invention.

The LED lighting unit 100 of the first modified example is different from the LED lighting unit 1 of the exemplary embodiment in view of points that a light transmitting housing 50 is provided in place of the light transmitting housing 10 and a light screen member 60 is provided in place of the light screen member 40.

Other structures are the same as those of the exemplary embodiment, and the same components as those of the exemplary embodiment are designated by the same reference numerals and signs.

The light transmitting housing 50 is different from the light transmitting housing 10 in view of a point that a fitting recessed part 51 is provided in place of the insert opening part 11.

The fitting recessed part 51 is a groove part recessed in a front wall 50a of the light transmitting housing 50 so that at least a part of the light screen member 60 is fitted thereto.

The light screen member 60 has a fitting protruding part 61 as a protruding part corresponding to a vertical line of a form of T which is fitted to the fitting recessed part 51.

In the above-described LED lighting unit 100, when the fitting protruding part 61 is fitted to the fitting recessed part, the light screen member 60 is held and fixed to the light transmitting housing 50.

In the LED lighting unit 100 of the first modified example, since the light screen member 60 screens lights guided in an inner part of the wall of the light transmitting housing 50 in the inner part of the wall so that lights emitted respectively from LED elements 22 are guided in the wall of the light transmitting housing 50 and do not interfere with each other, the same effects as those of the LED lighting unit of exemplary embodiment can be achieved.

### Second Modified Example

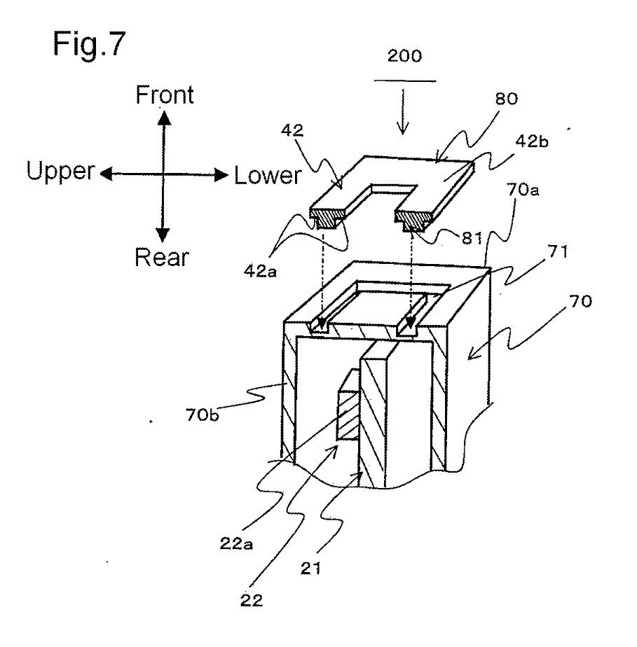

Now, a second modified example of the exemplary embodiment of the present invention will be described below by referring to FIG. 7. FIG. 7 is a sectional perspective view of main parts of an LED lighting unit 200 of a second modified example of the exemplary embodiment of the present invention. In the LED lighting unit 200 of the second modified example of the exemplary embodiment of the present invention, since a light screen cover 30 is the same as that of the LED lighting unit 1 of the exemplary embodiment, an illustration of the light screen cover 30 is omitted in FIG. 7.

The LED lighting unit 200 of the second modified example is different from the LED lighting unit 1 of the exemplary embodiment in view of points that a light transmitting housing 70 is provided in place of the light transmitting housing 10 and a light screen member 80 is provided in place of the light screen member 40.

Other structures are the same as those of the exemplary embodiment, and the same components as those of the exemplary embodiment are designated by the same reference numerals and signs.

The light transmitting housing 70 is different from the light transmitting housing 10 in view of a point that a fitting recessed part 71 is provided in place of the insert opening part 11.

The fitting recessed part 71 is a groove part recessed in a front wall 70a of the light transmitting housing 70 so that at least a part of the light screen member 80 is fitted thereto. The fitting recessed parts 71 are respectively formed in walls of the light transmitting housing 70 respectively located near two LED elements 22 and opposed to the LED elements 22 so as to surround the LED elements 22 respectively.

The light screen members 80 are respectively arranged in the walls of the light transmitting housing 70 respectively located near the plurality of LED elements 22 and opposed to the LED elements 22 so as to surround the LED elements 22 respectively. Namely, the light screen members 80 are formed in the walls of the light transmitting housing 70 respectively located near the plurality of LED elements 22 and opposed to the LED elements 22 so as to surround the LED elements 22 respectively. Fitting protruding parts 81 are fitted to the fitting recessed parts 71 so that the light screen members 80 are held and fixed to the light transmitting housing 70.

In the LED lighting unit 200 of the second modified example, since the wall of the light transmitting housing 70 located near and opposed to the LED element 22 can be partitioned by the light screen member 80 for each LED element 22, lights guided in the walls of the light transmitting housing 70 can be effectively screened. As a result, an interference of the lights respectively emitted from the LED elements 22 can be effectively prevented.

### Third Modified Example

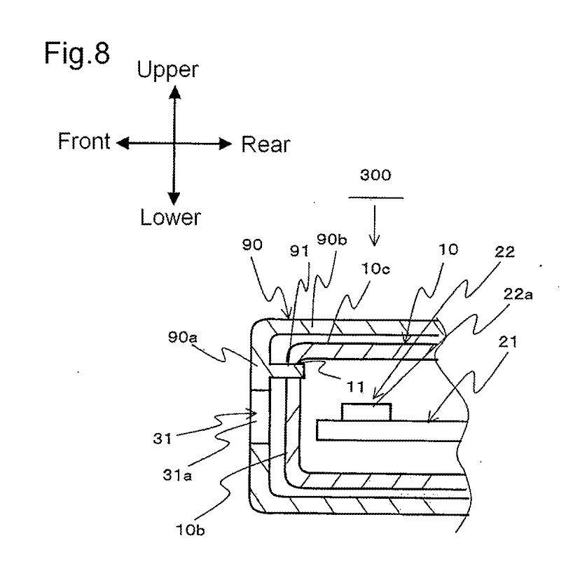

Now, a third modified example of the exemplary embodiment of the present invention will be described below by referring to FIG. 8. FIG. 8 is a sectional view of main parts of an LED lighting unit 300 of a third modified example of the exemplary embodiment of the present invention.

The LED lighting unit 300 of the third modified example is different from the LED lighting unit 1 of the exemplary embodiment in view of points that a light screen cover 90 is provided in place of the light screen cover 30 and the light screen cover 90 has a function of the light screen member 40.

Other structures are the same as those of the exemplary embodiment, and the same components as those of the exemplary embodiment are designated by the same reference numerals and signs.

The light screen cover 90 has an insert protruding part 91 inserted into an insert opening part 11 of a light transmitting housing 10.

The insert protruding part 91 protrudes from an inner surface of a front wall 90a of the light screen cover 90. Namely, the insert protruding part 91 has a light screen property.

In such a LED lighting unit 300, when the insert protruding part 91 is inserted into the insert opening part 11, the light screen cover 90 is attached to the light transmitting housing 10. That is, the insert protruding part 91 functions as a light screen member.

In the LED lighting unit 300 of the third modified example, since lights emitted respectively from LED elements and guided in a wall of the light transmitting housing 10 can be screened by the insert protruding part 91, the same effects as those of the LED lighting unit 1 of the exemplary embodiment can be achieved. Further, since a light screen member 40 does not need to be separately attached, an attaching operation is easy.

Further, in the LED lighting unit 300 of the third modified example, the light screen cover 90 and the light transmitting housing 10 can be integrally formed by a two-color molding.

In the LED lighting units 1, 100 and 200 according to the exemplary embodiment of the present invention, the light screen members 40, 60 and 80 whose material is a rubber material are exemplified. However, the present invention is not limited thereto. Namely, other materials having the light screen property may be used. For instance, a sponge material may be used. In this case, heat in the light transmitting housings 10, 50 and 70 may be exhausted outside through vent openings of the sponge material.

The LED lighting units 1, 100, 200 and 300 according to the exemplary embodiment of the present invention are exemplified which respectively include the front side LED elements 22a emitting the orange lights and the rear side LED elements 22b emitting the white lights. However, the present invention is not limited thereto. Namely, the LED lighting unit that has a plurality of LED elements which respectively emit the while lights or colored lights, may emit other colors.

Further, the LED lighting units 1, 100, 200 and 300 according to the exemplary embodiment of the present invention are exemplified which respectively include the two LED elements 22 of the front side LED element 22a and the rear side LED element 22b. However, the present invention is not limited thereto. Namely, the LED lighting unit may have a plurality LED elements 22.

Further, the LED lighting units 1, 100, 200 and 300 according to the exemplary embodiment of the present invention are exemplified in which the light screen members 40, 60 and 80 are arranged in the front walls 10b, 50a and 70a of the light transmitting housings 10, 50 and 70. However, the present invention is not limited thereto. Namely, when the light screen members are arranged so as to screen in the inner parts of the walls the lights guided in the walls of the light transmitting housings so that the lights emitted respectively from the plurality of LED elements 22 are guided in the walls of the transmitting housings and do not interfere with each others, the light screen members may be arranged in other walls of the light transmitting housings. For instance, the light screen members may be arranged on upper walls of the light transmitting housings.

The invention devised by the inventor is specifically described above in accordance with the above-described exemplary embodiment of the present invention. However, the present invention is not limited to the above-described exemplary embodiment and may be variously changed within a range which does not depart from the gist of thereof.

The present application is based on Japanese Patent Application No. 2011-095812 filed on Apr. 22, 2011, the contents of which are incorporated herein for reference.

### INDUSTRIAL APPLICABILITY

According to the present invention, the LED lighting unit 1 includes the circuit board on which the plurality of LED elements are mounted and the light transmitting housing in which the circuit board is accommodated. Further, the LED lighting unit includes the light screen cover which is formed so as to cover the outer surface of the light transmitting housing and has the light output opening parts formed on the walls respectively opposed to the plurality of LED elements and the light screen member which screens in the inner part of the wall the lights guided in the inner part of the wall of the light transmitting housing so that the lights respectively emitted from the plurality of LED elements are guided in the inner part of the wall of the light transmitting housing and do no interfere with each other. Accordingly, since the light screen member screens the lights in the wall of the light transmitting housing without enclosing the LED elements respectively in the individual spaces, even when the plurality of LED elements are provided on the circuit board, an interference of the lights can be reduced and a heat load applied to the circuit board can be reduced.

### REFERENCE SIGN LIST

1, 100, 200, 300: LED lighting unit;
10, 50, 70: light transmitting housing;
10a: front end part;
10b, 50a, 70a: front wall;
10c, 50b, 70b: upper wall;
11: insert opening part;
20: LED unit part;
21: circuit board;
21a: terminal;
22: LED element;
22a: front side LED element;
22b: rear side LED element;
30, 90: light screen cover;
30b,90a: front wall;
30c, 90b: upper wall;
30d: inner surface;
31: light output opening part;
31a: front side light output opening part;
31b: rear side light output opening part;
40, 60, 80: light screen member;
41, 91: insert protruding part;
42: abutting part;
42a: first abutting surface;
42b: second abutting surface;
51, 71: fitting recessed part;
61, 81: fitting protruding part; and
W: electric wire.

What is claimed is:

1. An LED lighting unit having a circuit board on which a plurality of LED elements are mounted and a light transmitting housing in which the circuit board is accommodated, the LED lighting unit comprising:
a light screen cover formed so as to cover an outer surface of the light transmitting housing and having light output opening parts formed on walls of the light screen cover respectively opposed to the plurality of LED elements and
a light screen member which screens in an inner part of walls of the transmitting housing lights guided in the walls of the transmitting housing so that the lights emitted respectively from the plurality of LED elements are guided in the walls of the transmitting housing and do not interfere with each other.

2. The LED lighting unit according to claim 1, wherein the light transmitting housing has an insert opening part as an opening formed on the wall of the transmitting housing so that at least a part of the light screen member is inserted, or a fitting recessed part recessed in the wall of the light transmitting housing so that at least a part of the light screen member is fitted thereto, and the light screen member is inserted into the insert opening part or fitted to the fitting recessed part so that the light screen member is held and fixed to the light transmitting housing.

3. The LED lighting unit according to claim 2, wherein the light screen member has a cross-sectional form of T and includes an insert protruding part as a protruding part corresponding to a vertical line of the form of T and inserted into the insert opening part or a fitting protruding part fitted to the fitting recessed part and an abutting part as a part corresponding to a transverse line of the form of T and having a first abutting surface as a surface of the insert protruding part side or the fitting protruding part side and allowed to abut on an outer surface of the light transmitting housing and a second abutting surface as a back side surface of the first abutting surface and allowed to abut on an inner surface of the light screen cover.

4. The LED lighting unit according to claim 1, wherein the light screen member is arranged on the wall of the light transmitting housing located near and opposed to each of the plurality of LED elements so as to surround each of the LED elements.

5. The LED lighting unit according to claim 2, wherein the light screen member is arranged on the wall of the light transmitting housing located near and opposed to each of the plurality of LED elements so as to surround each of the LED elements.

6. The LED lighting unit according to claim 3, wherein the light screen member is arranged on the wall of the light transmitting housing located near and opposed to each of the plurality of LED elements so as to surround each of the LED elements.
